(19) United States
(12) Patent Application Publication
(10) Pub. No.: US 2019/0387708 A1
(43) Pub. Date: Dec. 26, 2019

(54) COMBINATION MINERAL FEEDER AND LIVESTOCK SPRAYER

(71) Applicant: Huey Fussell, JR., Ambrose, GA (US)

(72) Inventor: Huey Fussell, JR., Ambrose, GA (US)

(21) Appl. No.: 16/252,546

(22) Filed: Jan. 18, 2019

Related U.S. Application Data
(60) Provisional application No. 62/618,632, filed on Jan. 18, 2018.

(51) Int. Cl. A01K 1/10; A01K 13/00

(52) U.S. Cl. CPC A01K 1/10; A01K 13/003

(57) ABSTRACT

A method and an apparatus providing a combination mineral feeder and livestock sprayer with a mineral feed compartment having a door and a sprayer actuated by movement of livestock into the door. The door includes a roller applicator for imparting liquid treatment to the nose and face of an animal. The apparatus combines a reservoir of chemical into the unit and a pump to the sprayer. The apparatus is secured by a mat or surround attached to the base of the apparatus that accommodates the livestock thereon during use.

### PRIORITY CLAIM

The present application claims benefit of U.S. provisional application Ser. No. 62/618,632 filed on Jan. 18, 2018.

### BACKGROUND OF THE INVENTION

### 1. Field of the Invention

This invention relates to nutrition and disease control for animals. In particular, the invention concerns a combination mineral feeder and chemical dispensing unit. The unit includes a reservoir of mineral and sprayer nozzles and roller dispensing. The combination imparts chemical treatment to livestock while feeding.

### 2. Discussion of the Prior Art

Farmers and cattle ranchers desire to protect their animals from disease. Maintaining an animal's health is most efficient. Whereas, treatment of illness is time consuming and expensive. Farmers optimize the health of cattle by monitoring nutrition and by controlling for flies, insects, and other pests. The farmer monitors nutrition by nutrient balancing and daily vitamin and mineral supplements. Among other benefits, mineral nutrition boosts vaccination response. Meanwhile, reducing flies and the like decreases cattle exposure to pest-borne disease vectors.

Generally, models that force the animal to get treatment around the head area are best for reducing face fly numbers. Existing methodologies include application of protectants through back-rubbers, oilers, and dust bags. Other methodologies include ear tags, pour-on treatments, oral treatments, and biological controls. Moreover, routine spraying controls difficult pests such as horn flies. Thus, liquid spraying is often the best option. Yet, spray treatments need reapplication after one to two weeks. During warm seasons, spraying animals uses excessive labor. And, spraying requires handling and confinement of cattle. These hurdles disincentivize ranchers from the suggested preventative treatment.

The prior art teaches many attempts to improve nutrition supplementation and pest control of a herd.

U.S. Pat. No. 5,063,880 to Rock J. Bouthillier teaches an automatic spraying device that detects animals for spraying and times the process for deactivating a pump.

U.S. Pat. No. 3,763,828 to Peter R. Tighe teaches a spray device with nozzle in a cow's passageway that the cow must step over to pass. The nozzle below the cow sprays upward to spray the cow's udder.

U.S. Pat. No. 4,379,440 to Thedford and Wilson teaches a livestock spray apparatus with a chute structure and rub panel to provide adjustable guidance for directing different sizes of animals through the chute. The apparatus includes a floor structure for solution filtration.

U.S. Pat. No. 4,987,861 to Lemire and Boyer teaches an apparatus for spraying animals that is mounted to an entranceway for animals. It consists of a U-shaped tubular structure.

U.S. Pat. No. 5,367,983 to Pound, Miller, and LeMeilleur teaches a device and method using a vertical support member carrying pesticide applicators that the animal contacts in the course of feeding for control of ticks or other ectoparasites.

U.S. Pat. No. 1,734,035 to Hargraves teaches a combination insecticide applicator and feeder that disperses chemical onto the animal by agitation.

U.S. Pat. No. 3,941,096 to Mann teaches an insecticide applicator for applying material to the face, head, and neck area of livestock that includes a hood, supported mineral block, and an insecticide dispensing device such as a porous fabric activated through agitation by the animal.

U.S. Pat. No. 4,580,529 to Wilson teaches a shed housing a feeder box in which the lid of the feeder box activates a sprayer for dispensing insecticide when the door of the feeder box closes.

U.S. Pat. No. 5,056,467 to Schaefer teaches an animal operated insecticide spray delivery system enclosed in a barrel housing. The spray system is activated by a feeder door, but Schaefer does not teach a mean for automatically dispensing material onto the bridge of the nose of the animal or multiple sprayer positions for delivery of chemical to the shoulders, back chest, belly, and side of an animal.

The prior art above does not teach a combination feeder/sprayer unit that is self-contained and that includes a dribbler/roller that automatically rolls along bridge of the nose of the animal and a sprayer configured multiple positions for delivering spray to the shoulders, back chest, belly, and side of the animal.

There is a continuing need to prevent disease in livestock caused by malnutrition and disease from pests such as flies. The treatment of livestock for nutrition and disease can be time consuming and inefficient. Therefore, a need exists for a combination livestock mineral feeder and sprayer in accordance with the present invention that further improve upon the art in the field.

### SUMMARY OF THE PRESENT INVENTION

Accordingly, the overall objective of this invention is to provide a novel combination mineral feeder and livestock sprayer that improves efficiency by combining the imparting of nutrition to the animals with the process of treating the animals with sprayed and rolled chemicals to deter pests.

The present apparatus is a combination mineral feeder and livestock sprayer with a roller applicator. The apparatus includes spray nozzles about the door of a mineral containing compartment of the apparatus, a roller attached to the door, and a reservoir with pumps for conveying insecticide. The entire apparatus includes a combination of the feeder and sprayer into a unit with the insecticide reservoir and pump system contained therein. The spray nozzles may be situated above and below the door to the compartment. A roller provided on the doorway of the compartment imparts chemical, such as insecticide, to the animal.

### Objects

An object of the present invention is to provide an apparatus comprising a combination mineral feeder and livestock sprayer in which all parts including a power source, pump, chemical reservoir, mineral reservoir, control, doors, sprayer components, roller components, and housing components form a self-contained unit for mounting in a selected position.

In another object, the apparatus is positioned and mounted onto a base mat on which the front legs of an animal stand to add stability.

In another object, an animal pushes a feeder door to activate a pump and dispense treatment to an animal by spraying.

In another object the spraying system delivers liquid treatment to the shoulders, back chest, belly, and sides of an animal.

In another object an animal pushes a feeder door to activates a dribbler delivering liquid onto a roller on the door, and the roller delivers treatment to the nose or face of an animal.

In another object the apparatus includes a separate door for refilling mineral feed.

In another object the apparatus includes door overhangs that protect the doorways.

In another object the apparatus includes a top spray nozzle above the feeder door to spray chemical on the top and side of the animal and a bottom spray nozzle to spray chemical on the legs and belly of the animal.

In another object the apparatus includes an internal ten-gallon tank for holding water and chemical.

In another object the apparatus includes a solar panel and a rechargeable battery providing power to the control.

In another object the control of the apparatus includes a timing means to activate and control the duration of spray.

In another object the control of the apparatus includes a timer and agitator pump to agitate water or chemical in the tank.

In another object the feeder door entrance design limits visibility of the sprayer nozzles preventing animal fear.

In another object of the apparatus a removable top lid covers several components of the apparatus securing the components from animals while maintaining accessibility for filling the water and chemical reservoir or for repair or replacement of the components.

### BRIEF DESCRIPTION OF THE FIGURES

FIG. 1 is a perspective view of an embodiment of the invention of a new combination mineral feeder and livestock sprayer.

FIG. 2 is an exploded perspective view of the invention of FIG. 1.

FIG. 3A is a rear perspective view of the invention of FIG. 1 showing the mineral feed refill door closed.

FIG. 3B is a rear perspective view of the invention of FIG. 1 showing the mineral feed refill door open.

FIG. 4 is a top view of the invention of FIG. 1 with the cover of the apparatus removed to show the water tank chemical reservoir, water port, pump, control board, and battery.

FIG. 5 is a cut-away left side view of the invention of FIG. 1 showing the various aspects and features of the exemplary embodiment.

FIG. 6 is a cut-away left side view of the invention of FIG. 1 depicting operation of the apparatus with livestock.

FIG. 7 is a schematic view showing the method for setting up the combination mineral feeder and livestock sprayer shown in FIG. 1.

FIG. 8 is a schematic view showing the method and process for treatment of an animal using the combination mineral feeder and livestock sprayer shown in FIG. 1.

### DETAILED DESCRIPTION OF THE INVENTION

The following description provides the reader with a better understanding of the invention. The description does not limit the invention with respect to any element not otherwise limited by the claims.

The present invention discloses an apparatus and method that provides a combination mineral feeder and livestock sprayer. The combination unit 2 transfers a chemical treatment from a liquid reservoir 40 contained in the unit to an animal 22. Chemical transfers using sprayer nozzles 50, 60 and a roller applicator 70 of a roller component while an animal feeds on mineral 82 via a mineral reservoir 80.

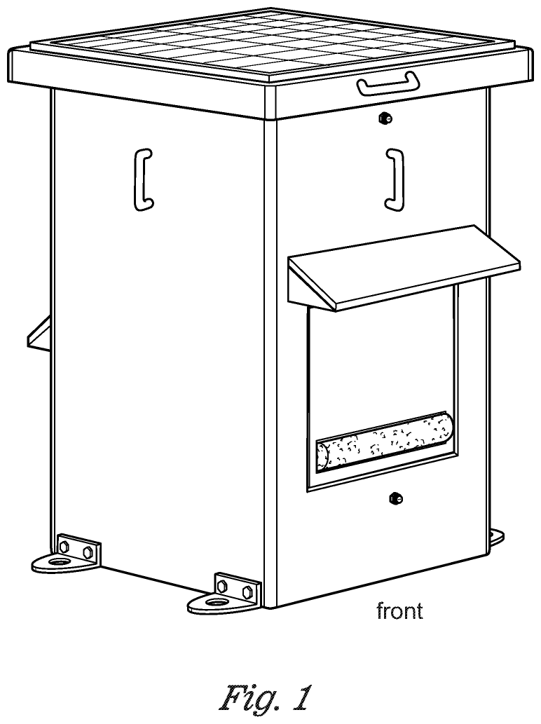

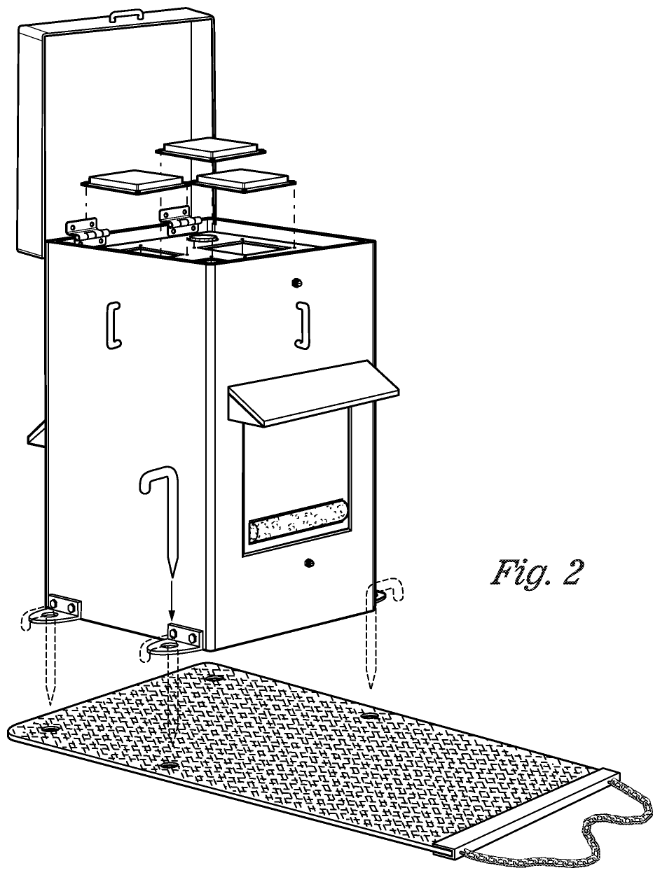

Referring now to the drawings, FIG. 1 shows an apparatus constructed in accordance with an embodiment of the invention. The apparatus includes a housing 3 and top lid 8 covering the housing. The housing 3 forms the exterior front side 4, rear side 5, and opposing left side 6 and right side 7 of the self-contained unit 2, and the housing mounts to a selected position for access by animals. Several feet 10 or other attachment brackets append to a base portion of the housing 3 at the bottom of the sides 6, 7. In FIG. 1 the feet 10 as shown attach by bolts 12 via a flange member 14 to a bottom edge of opposing side walls of the housing. The feet each include an extension member 16 that extends horizontal and perpendicular to the bottom edge so that the feet 10 will rest on a flat surface such as a mat 20 as shown in FIG. 2. The feet each include a hole 18 in the extension member for insertion of a stake 19 or other ground attachment device.

FIG. 2 shows an assembly of the apparatus, self-contained unit parts, and installation of the unit on the mat 20. As shown, the unit 2 mounts to the selected position by installation on the base mat 20. The stakes 19 insert through the holes 18 in the extension members 16 of the feet 10. The stakes 19 proceed through several holes 21 in the base mat and secure the unit to the ground. Alternatively, the base mat 20 comprises a plastic sheet or plastic mat that surrounds or extends from the base of the unit 2.

The base mat 20 may include an elongate construction of chainmail or plastic. An exposed portion of the mat extends beyond the edge of the unit 2, particularly the front of the unit. Front legs of the animal 22 feeding at the unit stand on the exposed portion in front of the unit and the weight of the animal increases stability of the unit, whereby animals are incapable of causing damage to the unit. The apparatus is secured so that livestock are unable to turn the apparatus over while feeding.

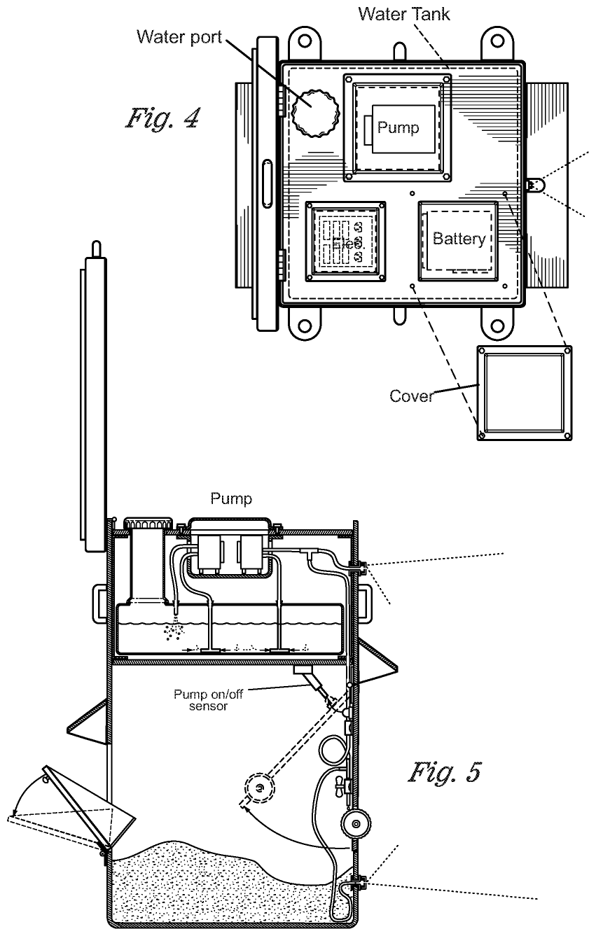

The self-contained unit 2, as shown in FIG. 2, and FIGS. 4-6 includes a powered control 30 and pump system 24 contained within the top section of the unit. The system includes a combination of electronic control 30, pump 24, and battery 28. The power source shown in FIG. 4 includes the battery 28. In one embodiment, the battery is rechargeable and recharges through a solar panel 26 connected as the power source. The battery 28 connects to the electronic control 30 and the pump 24 to operate the components for dispensing chemical treatment when actuated by an animal.

As shown in FIGS. 1 and 2, the self-contained unit 2 includes a feeder door 32, the animal pushes the feeder door open to access a reservoir 80 of mineral feed 82. When the animal pushes the feeder door 32, the movement of the door actuates the electronic control 30 that controls the pump and timing of chemical treatment. Upon actuation by movement of the door, the control initiates a timing mechanism in the control 30 to measure and control the duration of spray of chemical for treatment of the animal and initiates dispensing of chemical to the roller applicator 70 of the roller component.

The top lid 8 shown in the FIGS. 1-6 lifts to expose the several components of the self-contained unit 2. The lid 8 is weighted and removable or hinged according preference. The top lid 8 secures components including the liquid chemical reservoir 40 holding the liquid 42 for treatment and reservoir cap 44, the pump 24, the control 30, and the power supply battery 28 to protect those components from damage by the animals or environment. Meanwhile, as shown in FIG. 4, the lid 8 maintains accessibility to the components for refilling the chemical and water reservoir 40. The reservoir cap 44 on the water port shown in FIG. 4 is removed while the lid 8 is tilted upward or removed whereas chemical and water might be poured into the liquid reservoir tank 40. The lid 8 also allows repair or replacement of the components if needed.

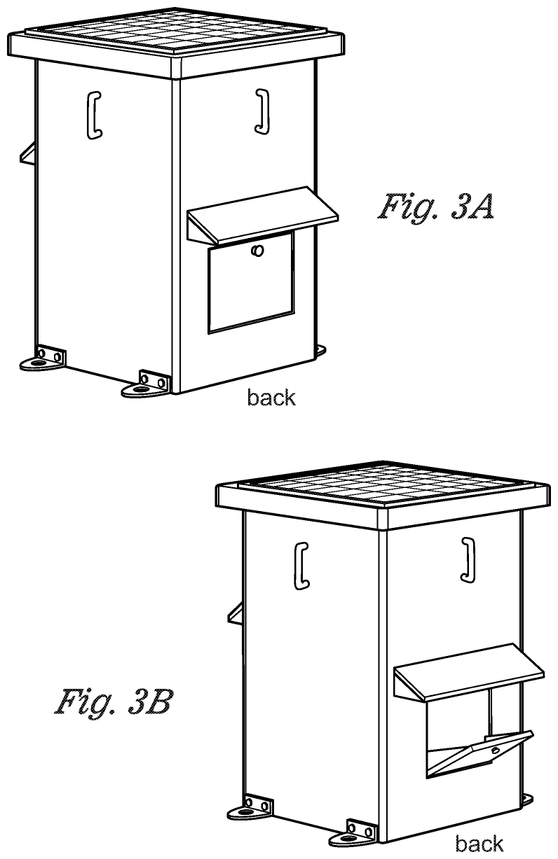

FIG. 3A and FIG. 3B show an embodiment comprising a rear refill door 36 on the back side 5 of the self-contained unit 2. The refill door 36 permits access to a mineral reservoir 80 inside the lower section of self-contained unit 2 for refilling the mineral 82. The cut-away view of FIG. 5 illustrates the refill door 36 in alternating position between open and closed and the mineral in the feeder accessible through the door for refill. The door 36 opens from the top so that an animal cannot access the mineral 82 through the refill door. The door may be latched or spring-loaded and hinged on the bottom by a hinge 37. For additional security against animal intrusion, a door flange 34 extending from the bottom of the refill door 36 closes the access portal of the refill door if the door is opened too far.

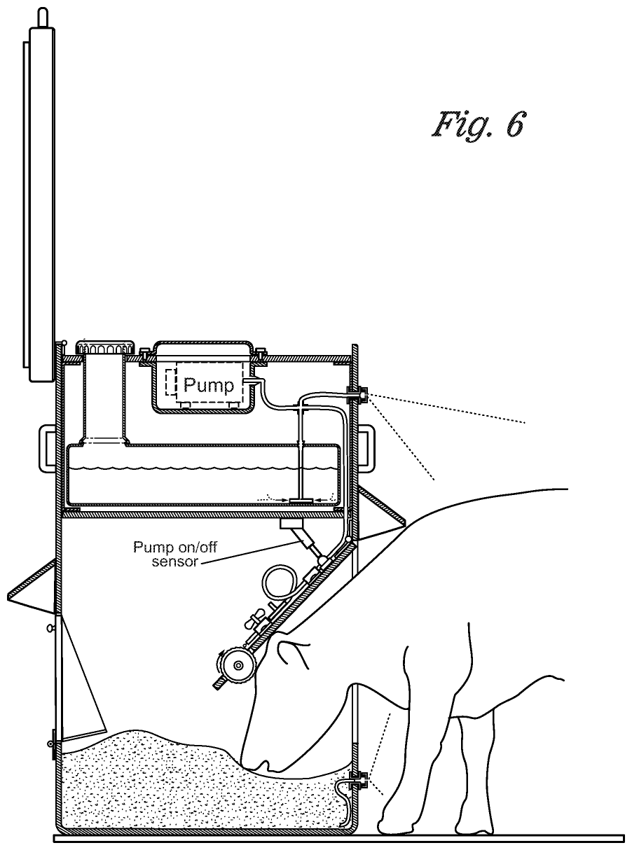

FIG. 5 and FIG. 6 illustrate the sprayer and roller components of the self-contained unit 2 in more detail. Several spray nozzles are situated about the feeder door 32 of the unit for application to several areas of the animal's body. At least one first nozzle 50 is attached above the feeder door 32 on the front side 4 about the top section of the unit 2. A first tube 52 connects the first nozzle 50 to the pump 24 controlled by the electronic control 30. The first tube 52 transfers chemical from the chemical reservoir 40 to the first nozzle 50 as determined by actuation by the animal and the control system. The feeder door 32 entrance design includes a front overhang 38. The front overhang performs several functions. First, the front overhang 38 protects the feeder door 32 and roller applicator 70 from the environment and damage. Second, the front overhang design limits visibility of the first nozzle 50 situated above the animal while the animal 22 enters the feeder door 32 head first to feed. The design prevents the animal seeing spray emanate from the nozzle 50 and prevents development of fear of the spray by the animal. The top first nozzle 50 dispenses a spray of chemical treatment to the shoulders, back chest and sides of the animal.

At least one second nozzle 60 is located below the feeder door 32 and attaches to the pump 24 and reservoir 40 through a second tube 62. Chemical treatment fluid flows from the reservoir to the second nozzle 60 via the pump mechanism operated by the control 30. The second nozzle 60 below the door dispenses treatment on the legs and belly of the animal 22.

A roller component including the roller applicator 70 attaches near the bottom of the feeder door 32, whereby the roller applicator is contacted by the animal 22 after the animal proceeds to open the feeder door to access the mineral feed 82. The roller component includes an axial member 76 for the roller applicator 70 to rotate on as the animal moves the door 32 further into the open position. Fluid from the chemical and water reservoir 40 dispenses onto the roller applicator via transfer from the reservoir by a third tube 74. Like the first and second tubes 52, 62, the amount of fluid dispensed onto the roller applicator 70 depends upon the electronic control 30 as programmed to activate the pump 24. The pump transfers the fluid through the third tube to a dribbler 72 or spray means that imparts a determined amount of fluid onto the roller applicator 70. A screw-in adjustment pin 78 may be attached about the third tube 74 to partially block the tube and control the amount of fluid dispensed by the dribbler nozzle 72. A hand operated handle of the adjustment pin 78 operates the screw to open or close the valve created in the tube 74 by the pin. As the animal opens the feeder door 32, the animal's nose and bridge of the nose contacts the roller applicator 70 and causes the roller to rotate or press against the animal's skin to deliver treatment to the animal's nose or face. In addition, as the feeder door 32 opens, a contact 92 on the interior side of the feeder door 32 presses a pressure sensor 94 or any other sensor mechanism to actuate the pump control 30 and control flow of fluid in the third tube line 74.

As shown in the cut-away views of FIG. 5 and FIG. 6, the unit includes a mineral compartment formed by a surrounding wall of the housing 3 about the perimeter and a bottom comprising a pan forming the bottom 9 of the housing and holding mineral feed 82. Alternatively, a removable pan might be placed within the lower section of the housing 3 of the unit 2, inside of and separable from the housing itself. The mineral compartment is positioned below the bottom of the feeder door 32 for access by the animal 22. Mineral feed 82 may fill the mineral compartment to a determined level, and the farmer may refill the feed through the rear refill door 36.

FIG. 5 and FIG. 6 clearly illustrate a liquid reservoir tank 40 located in the upper section of the housing 3 of the combination unit 2. The liquid reservoir may include a ten-gallon tank 40 for holding water and chemical, such as insecticide. A pump 24 or pumps convey the liquid 42 from the reservoir tank 40 to the sprayer nozzles 50, 60 and roller applicator 70. An agitator 90 connects to the tank 40 to agitate water or chemical in the reservoir. A timer may electronically connect to the agitator to signal need for agitation to maintain a proper mixture of chemical.

In the embodiment shown, the liquid reservoir tank 40 is located beneath the pump 24 and mounted to a first intermediate horizontal support member 96 connected between the walls and sides of the housing 3. The support member 96 provides a mounting surface for the tank 40, additional structural support for the housing, and support for the weight of liquid 42 held in the tank. The support member 96 also provides an interior surface for mounting the pump on/off sensor 94 shown in FIG. 5. or other components as needed to adapt the unit to the desired configuration. An additional bracket member 98 may be integrated into the sides or front and back of the housing 3 to structurally support the upper section of the housing. The brackets 98 shown in FIG. 5 attach to the side walls and attach between the first intermediate horizontal support member 96 and a second top horizontal support member 100 that is located near the top of the housing 3. Components such as the electronic control 30, battery 28, and pump 24 may mount to the second top horizontal support member 100. A port 102 extends through the second support member 100 to provide a conduit for filling the liquid reservoir tank 40.

As shown in FIGS. 1-8, the invention provides a new and novel combination mineral feeder and livestock sprayer with improved features to make application of insecticide to livestock more convenient, combining animal nutrition management with pest treatment. The apparatus includes spray nozzles about the door of a mineral containing compartment of the apparatus, a spray roller, and a reservoir with pumps for conveying insecticide. The entire apparatus includes a combination of the feeder and sprayer into a unit with the insecticide reservoir and pump system contained therein. The spray nozzles may be situated above and below the door to the compartment. A spray roller may be provided on the doorway of the compartment to impart chemical, such as insecticide, to the animal.

In the exemplary embodiment, a tank inside the top of the feeder forms a reservoir for the insecticide. Above the tank, the apparatus includes a control board, battery, and pump for controlling the release of insecticide from the reservoir. A trigger sprayer on the doorway of the mineral feeder section of the apparatus is actuated by the application of force by livestock on the door of the feeder section.

A pressure relief valve may be provided in combination with the sprayer lines to return any excess spray back to the tank reservoir to conserve the chemicals.

The mineral feed compartment is filled for access by livestock through the door. A refill door may be provided on the opposing rear side of the mineral feed compartment for refill of the mineral.

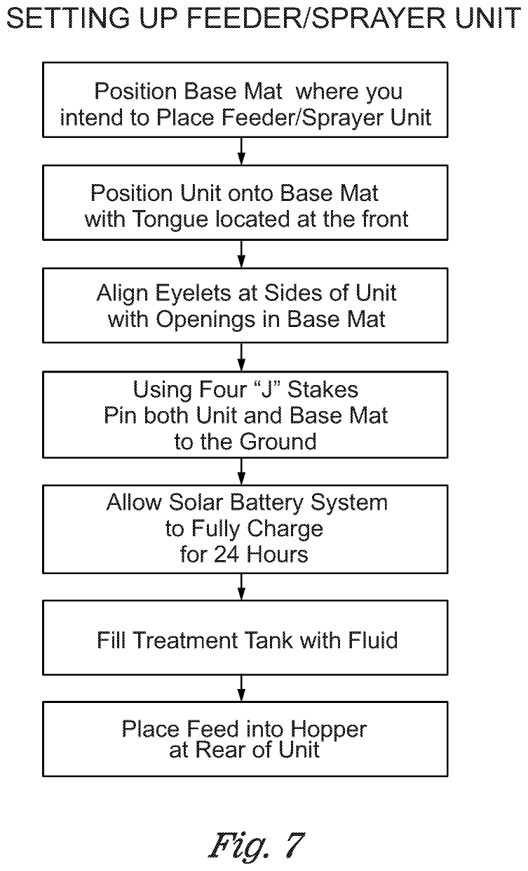

In the method of FIG. 7, a method is schematically illustrated for a combination mineral feeder and livestock sprayer. In a first step for setting up a feeder and sprayer unit, the combination unit is positioned on a base mat in a determined location for treatment of animals. A second set positions the unit onto the base mat with a tongue of the base mat located at and in front of the combination unit. Thereafter, in a third step the combination unit includes a housing and includes eyelets or holes at the left and right sides of the housing of the combination unit. The eyelets or holes align at the left and right sides of the combination unit with openings or holes in the base mat. In a fourth step, four stakes, such as “J” stakes are inserted through the holes at the left and right sides of the housing of the combination unit and inserted through the openings or holes in the base mat. Whereby, the stakes pin both the combination unit and the base mat to the ground. In a fifth step, a solar panel collect energy and transfer power to a battery or solar battery system on the combination unit. The solar battery system charges for a determined period of time to fully charge the battery, about 24 hours in the embodiment practiced. In a sixth step, a chemical and water reservoir provides a treatment tank, and the treatment tank is filled with fluid. In a seventh step, feed is placed into a hopper at the rear of the combination unit to fill a feed reservoir. These steps set up the feeder/sprayer to provide a combination of mineral nutrition and spray treatment of animal livestock.

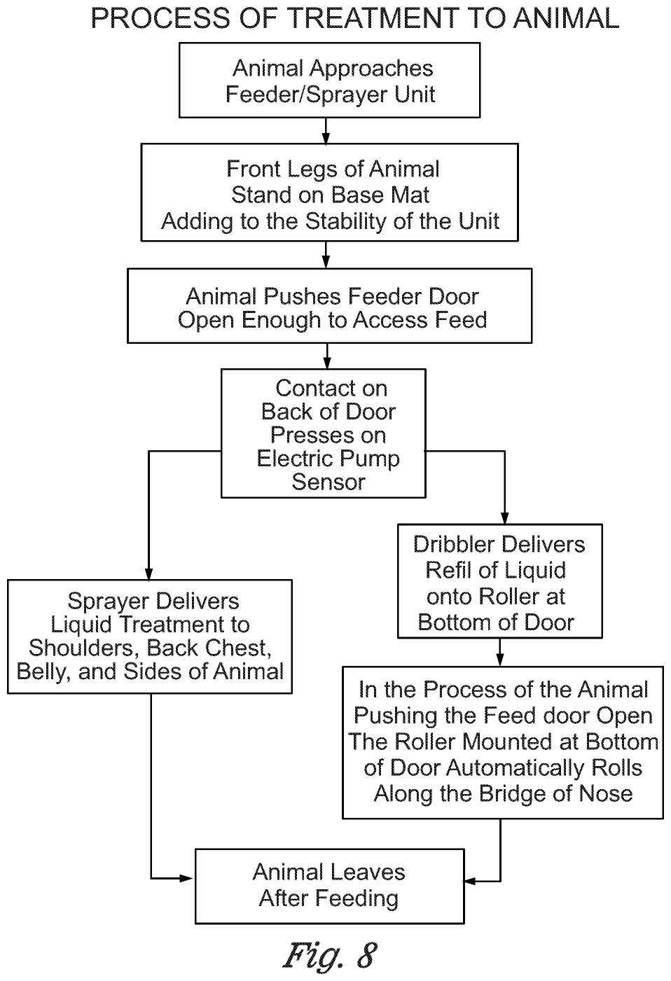

In FIG. 8 a flow chart schematically illustrated a process for treatment of an animal with a combination mineral feeder and livestock sprayer. In the steps shown the animal approaches the combination unit referred to in the schematic as the feeder/sprayer unit. Next, the front legs of the animal stand on the base mat, adding to the stability of the combination unit. The animal seeking feed pushes the feeder door open enough to access the mineral feed through the door. As the animal pushes the feeder door open, a contact on the inside or back of the feeder door presses on an electric pump sensor. Alternative sensors include any pressure sensor, motion sensor, or relay that activates the control system of the combination unit. After the movement of the feeder door activates the sensor, the process delivers a chemical treatment to the animal by multiple mechanisms that cover the head, face, back chest, sides, legs, and belly of the animal. In a first concurrent step, the pump causes a sprayer to deliver liquid treatment to the shoulders, back chest, belly, and sides of the animal. In a second concurrent step, the pump causes a dribbler to deliver refill liquid onto a roller positioned at the bottom of the feeder door. In the process of this this second concurrent step, the animal pushing the feed door open causes the roller mounted at the bottom of the door to automatically roll along the bridge of the animal's nose, whereby the roller treats the nose and face of the animal. After receiving the concurrent applications of chemical treatment and after feeding, the animal leaves. A control system or timer may determine the duration and amount of chemical treatment during the concurrent application steps.

These and other embodiments are disclosed by the annotation and figures included in this specification. Further, these and other embodiments may be apparent to those skilled in the art and within the scope of the invention.

I claim:

1. A combination mineral feeder and livestock sprayer comprising:
a housing with front side, rear side, left side, right side, bottom, and top lid;
a reservoir within the housing for holding a treatment fluid;
a pump, an electronic control controlling the pump, and a battery providing power to the electronic control and pump;
a feeder door on the front side of the housing;
a first spray nozzle attached to the housing above the feeder door and receiving the treatment fluid;
a second spray nozzle attached to the housing below the feeder door and receiving the treatment fluid; and
a roller applicator attached to the feeder door and receiving the treatment fluid.
